(19) United States
(12) Patent Application Publication
(10) Pub. No.: US 2017/0219412 A1
(43) Pub. Date: Aug. 3, 2017

(54) METHOD AND A SYSTEM FOR METERING FLOW THROUGH A FLUID CONDUIT

(71) Applicant: ABB Schweiz AG, Baden (CH)

(72) Inventor: Han van Dal, Lage Mierde (NL)

(21) Appl. No.: 15/420,128

(22) Filed: Jan. 31, 2017

(30) Foreign Application Priority Data
Feb. 1, 2016 (EP) 16153571.1
Feb. 25, 2016 (EP) 16157348.0

(51) Int. Cl. G01F 25/00; G01F 1/36

(52) U.S. Cl. CPC G01F 25/0007; G01F 1/36

(57) ABSTRACT

A method and a system of metering flow through a fluid conduit with a fluid obstruction, the method involves: measuring a differential pressure taken between a first conduit position upstream of the fluid obstruction and a second conduit position downstream of the fluid obstruction; calculating a fluid flow rate using the differential pressure measurement; measuring a first static pressure upstream or downstream of the fluid obstruction; measuring a recovered pressure at a recovered pressure location downstream of the fluid obstruction; performing diagnostics based on parameters derived from the differential pressure, the first static pressure; and the measured recovered pressure.

### CROSS-REFERENCE TO RELATED APPLICATIONS

Priority is claimed to European Patent Applications No. 16 153 571.1 and 16 157 348.0, respectively filed Feb. 1 and 25, 2016, the entire disclosure of each of which is hereby incorporated by reference herein.

### FIELD

The invention is about a method of metering flow through a fluid conduit

### BACKGROUND

Many industrial processes use or operate upon various types of fluids. During operation of the process, the fluids may be transferred through process piping from one location to another. In many instances, it is desirable to monitor the flow of such fluid through the process piping. The monitoring can be used for measurement purposes alone, or can be used in a control system. For example, a valve can be controlled based upon the amount of flow of process fluid which is measured.

Process variable transmitters are used to measure process variables of industrial processes. One such process variable is flow of process fluid. Various techniques can be used to measure such flow. One such technique measures flow based upon a differential pressure developed across a flow restriction element or flow obstruction, placed in the process piping. The differential pressure can be measured by a differential pressure transmitter and used to calculate the flow of process fluid. The flow restriction element placed in the flow causes various pressures to be developed, as described in WO2008/025935.

Differential pressure flow measurement is based on a flow restriction element that creates a pressure drop in the process fluid. Traditionally the differential pressure measurement is based on two pressure tappings, one upstream of the flow restriction element and one downstream at a position close to the point with the lowest pressure. A differential pressure transmitter is used to measure the pressure drop over the flow restriction element. From the pressure drop the flow rate can be calculated by using the Bernoulli equation. The equation also requires the density of the fluid that is typically calculated by a flow computer based on a pressure and temperature measurement.

Various diagnostic techniques have been implemented in process variable transmitters. Many techniques related to differential process flow measurement are based upon monitoring statistical variations in detected pressure in order to identify problems associated with the impulse lines which couple the transmitter to the process fluid. For example, if an impulse lines become plugged, a change in the standard deviation of the signal may be detected.

WO2008/025935 discloses a diagnostic technique which is based on a third pressure tapping. As discussed in WO2008/025935, a primary element creates a number of differential pressures in a flowing process fluid. By using a third tapping further downstream at a point where the pressure has recovered from the flow disturbance, two additional differential pressure measurements can be configured. For each of the three differential pressure transmitters a mass flow rate can be calculated. As there are three flow rate equations predicting the same flow through the same flow restriction element there is the potential for comparison and hence diagnostics. Furthermore for any flow restriction element operating with single phase homogenous flow, the ratio of the Permanent Pressure Loss PPL to the traditional DP is a constant value, resulting in a further parameter for diagnostics.

The prior art diagnostics techniques based on comparing flow rates measured by various differential pressure transmitters require a variety of mass flow calculations with associated calibration requirements, turning flow metering diagnostics complex.

### SUMMARY

An aspect of the invention provides a method of metering flow through a fluid conduit, the conduit having a fluid obstruction, the method comprising: measuring a differential pressure taken between a first conduit position upstream of the fluid obstruction and a second conduit position downstream of the fluid obstruction; calculating a fluid flow rate using the differential pressure measurement; measuring a first static pressure upstream or downstream of the fluid obstruction; measuring a recovered pressure at a recovered pressure location downstream of the fluid obstruction; and performing diagnostics based on parameters derived from the differential pressure, the first static pressure, and the measured recovered pressure.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a simplified schematic of the process piping with the flow restriction element and the location of the transmitters according to a first embodiment of the invention;

FIG. 2 plots of the profile of the static pressure against position in the process piping shown in FIG. 1;

FIG. 3 a more detailed schematic of the flow metering system according to the first embodiment of the invention;

FIG. 4 a more detailed schematic of the flow metering system according to a second embodiment of the invention;

FIG. 5 a more detailed schematic of the flow metering system according to a third embodiment of the invention;

FIG. 6 a more detailed schematic of the flow metering system according to a fourth embodiment of the invention;

FIG. 7 a more detailed schematic of the flow metering system according to a fifth embodiment of the invention; and

FIG. 8 a simplified schematic of the process piping with the flow restriction element and the location of the transmitters according to a sixth embodiment of the invention.

### DETAILED DESCRIPTION

In the light of the discussion in the Background, it is an aspect of the present invention to create a method of metering flow through a fluid conduit and a related flow metering system which provides for a less complex and improved diagnostic technique.

An aspect of the invention provides a method of metering flow through a fluid conduit, which comprises a fluid obstruction, the method comprising the steps of measuring a differential pressure taken between a first conduit position upstream of the fluid obstruction and a second conduit position downstream of the fluid obstruction, and calculating a fluid flow rate using the differential pressure measurement.

An aspect of the invention provides a flow metering system, comprising a fluid conduit, said fluid conduit comprising a fluid obstruction, said flow metering system further comprising a first pressure tapping at a location upstream of the fluid obstruction and a second pressure tapping at a location downstream of the fluid obstruction and a differential pressure transmitter arranged for measuring the differential pressure between the first and second pressure tapping.

An aspect of the invention relates to industrial process control or monitoring systems. More specifically, aspects of the present invention relate to systems which measure flow of process fluid in an industrial process.

According to an aspect of the invention, the method further comprises the steps of measuring a first static pressure upstream or downstream of the fluid obstruction, measuring a recovered pressure at a recovered pressure location downstream of the fluid obstruction, performing diagnostics based on parameters derived from the differential pressure, the first static pressure and the measured recovered pressure.

An advantage of the method according to an aspect of the invention is that diagnostics according to the invention relies just on one differential pressure and two static pressure measurements, which turns diagnostics less complex than known in the prior art. Additionally, the method according to an aspect of the invention provides the possibility to perform easy diagnostics for the static pressure measurement in addition to diagnostics for the fluid obstruction element an d the differential pressure measurement.

According to a preferred embodiment, the method further comprises the step of performing diagnostics based upon observing a trend in changes of diagnostic parameters derived from the differential pressure, the first static pressure and the measured recovered pressure.

According to a preferred embodiment, the method further comprises the step of deriving a calculated recovered pressure downstream of the fluid obstruction from the differential pressure and the first static pressure, and deriving a diagnostic parameter from the calculated recovered pressure and the measured recovered pressure.

According to a preferred embodiment, the method further comprises the steps of deriving the diagnostic parameter from the deviation between the calculated recovered pressure and the measured recovered pressure, and observing a trend of the deviation between the calculated recovered pressure and the measured recovered pressure, and indicating a diagnostic issue once said deviation exceeds an expected value.

According to a preferred embodiment, the method further comprises the steps of measuring a second static pressure downstream of the fluid obstruction in case the first static pressure is measured upstream of the fluid obstruction or measuring a second static pressure upstream of the fluid obstruction in case the first static pressure is measured downstream of the fluid obstruction, and performing diagnostics based on parameters derived from the differential pressure, the first static pressure, the measured recovered pressure and the measured second static pressure.

According to a preferred embodiment, the method further comprises the step of performing diagnostics based upon observing a trend in changes of parameters derived from the differential pressure, the first static pressure, the measured recovered pressure and the measured second static pressure.

According to a preferred embodiment, the method further comprises the steps of deriving a calculated second static pressure downstream of the fluid obstruction in case the first static pressure is measured upstream of the fluid obstruction or deriving a calculated second static pressure upstream of the fluid obstruction in case the first static pressure is measured downstream of the fluid obstruction from the differential pressure and the first static pressure, and deriving a further diagnostic parameter from the measured second static pressure and the calculated second static pressure.

According to a preferred embodiment, the method further comprises the steps of deriving said further diagnostic parameter from the deviation between the measured second static pressure and the calculated second static pressure, and observing a trend of the deviation between the measured second static pressure and the calculated second static pressure, and indicating a diagnostic issue once the deviation exceeds an expected value.

According to an aspect of the invention, the flow metering system further comprises a recovered pressure tapping at a recovered pressure location downstream of the second pressure tapping, a first pressure transmitter arranged for measuring the static pressure at the first pressure tapping or a first pressure transmitter arranged for measuring the static pressure at the second pressure tapping, a recovered pressure transmitter arranged for measuring the static recovered pressure at the recovered pressure tapping, a circuitry configured to perform diagnostics based on parameters derived from the differential pressure, the first static pressure and the measured recovered pressure.

According to a preferred embodiment, the system further comprises a second pressure transmitter arranged for measuring the static pressure at the second pressure tapping in case the first pressure transmitter is arranged at the first pressure tapping or further comprising a second pressure transmitter arranged for measuring the static pressure at the first pressure tapping in case the first pressure transmitter is arranged at the second pressure tapping, the circuitry being further configured to perform diagnostics based on parameters derived from the differential pressure, the first static pressure, the measured recovered pressure and the measured second static pressure.

According to a preferred embodiment, the transmitters are configured for communicating with each other.

According to a preferred embodiment, the circuitry is located within one of the transmitters.

According to a preferred embodiment, at least one of the transmitters is configured for communication with a central location.

According to a preferred embodiment, the circuitry is located within the central location.

The method and system according to an aspect of the current invention is also based on three pressure tappings, but uses a single differential pressure transmitter and multiple absolute pressure transmitters instead. The differential pressure transmitter is installed at the traditional upstream and downstream tappings. The first pressure transmitter is installed at the upstream pressure tapping, while a recovered pressure transmitter is installed at the tapping at the recovered pressure location. Optionally a second pressure transmitter is installed at the downstream pressure tapping.

In the scope of an aspect of the invention, it is also possible to install the first pressure transmitter at the downstream pressure tapping and the optional second pressure transmitter at the upstream pressure tapping.

The diagnostics method according to an aspect of the current invention is based on the fact that the static pressure at the recovered pressure location is both measured and calculated.

In case the first pressure transmitter is installed at the upstream pressure tapping, the calculated recovered pressure P3c is based on the measured upstream static pressure P1m and the permanent pressure loss PPL:

P3c=P1m−PPL (1)

In case the first pressure transmitter is installed at the downstream pressure tapping, the calculated recovered pressure P3c is based on the measured downstream static pressure P1m′, the differential pressure and the permanent pressure loss PPL:

P3c=P1m′+DP−PPL (1′)

Several different equations for the calculation of the PPL are available from literature. Most equations express the PPL as a ratio of the differential pressure DP. A simple equation known from literature for orifice plates, which is only a function of the Beta ratio, is reproduced in equation (2) below. The Beta ratio is defined as the diameter of the flow restriction element relative to the internal pipe diameter.

PPL=DP*[1.033−0.8552*(Beta ratio ̂1.5)] (2)

A deviation between the calculated recovered pressure P3c and the measured recovered pressure P3m larger than expected indicates an issue with one of the components.

Optionally a second pressure transmitter is configured at either the downstream pressure tapping, in case the first pressure transmitter is located at the upstream pressure tapping, or at the upstream pressure tapping, in case the first pressure transmitter is located at the downstream pressure tapping. This enables an additional check by comparing the measured downstream pressure P2m with a calculated downstream pressure P2c in case the first pressure transmitter is located at the upstream pressure tapping, see equation (3), or by comparing the measured upstream pressure P2m′ with a calculated upstream pressure P2c′ in case the first pressure transmitter is located at the downstream pressure tapping, see equation (3′):

P2c=P1m−DP (3)

P2c′=P1m′+DP (3′)

Monitoring the deviation between the calculated downstream pressure P2c and the measured downstream pressure P2m values, or between the calculated upstream pressure P2c′ and the measured upstream pressure P2m′ values, provides an additional parameter, making the diagnostics more sensitive for potential issues and allowing for a more accurate identification of the failing component.

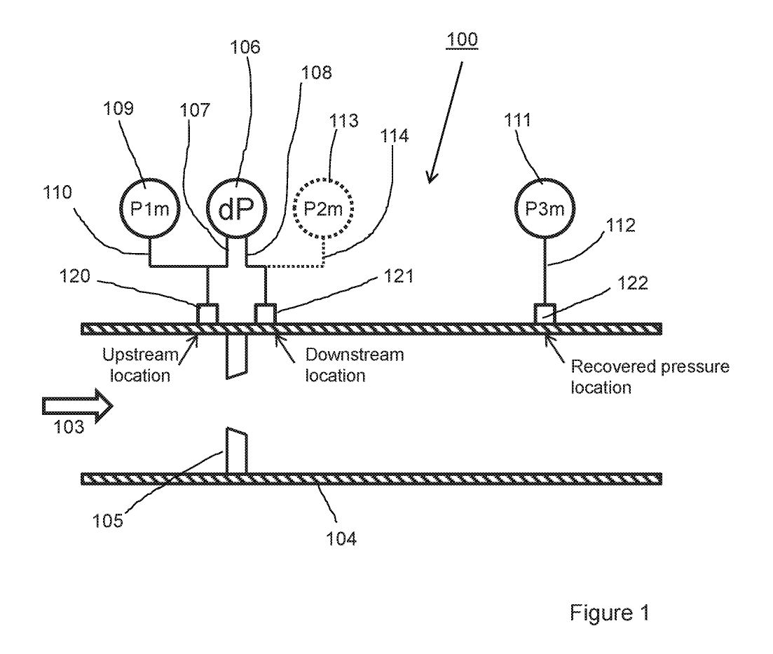

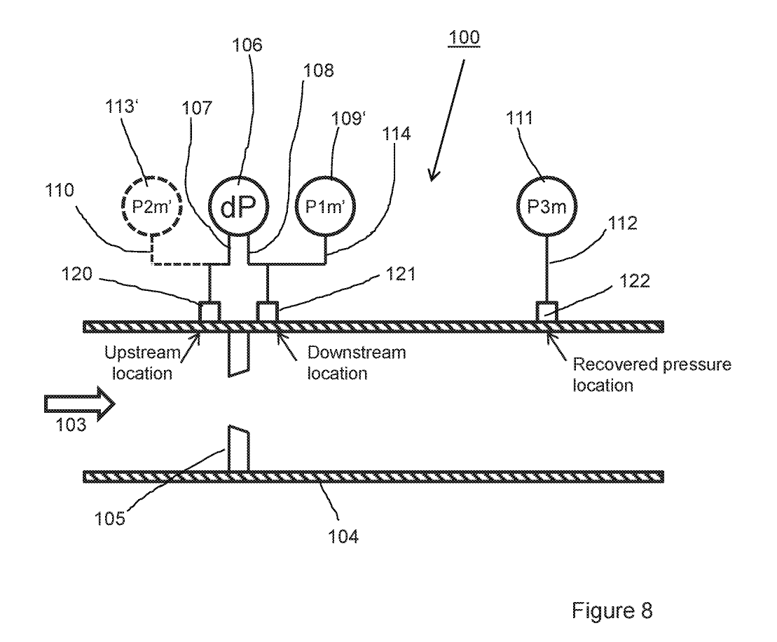

Looking first at FIG. 1, this shows a simplified schematic of the process piping 104 with the flow restriction element 105 and the location of the transmitters 109, 106, 113, 111 according to a first embodiment of the invention. Here the first pressure transmitter 109 is located at the upstream pressure tapping 120, and an optional second pressure transmitter 113 is located at the downstream pressure tapping 121. FIG. 8, in comparison, shows an alternative schematic of the process piping 104 with the flow restriction element 105 and the location of the transmitters 113′, 106, 109′, 111, where the first pressure transmitter 109′ is located at the downstream pressure tapping 121, and an optional second pressure transmitter 113′ is located at the upstream pressure tapping 120.

Turning back to FIG. 1, this shows a system 100 for measuring flow of a process fluid 103 through process piping 104 by means of an orifice plate as the flow obstruction or flow restriction device 105. A differential pressure transmitter 106 is connected to the process piping 104 through impulse piping 107 at a first pressure tapping 120 upstream of the flow restriction element 105, and impulse piping 108 at a second pressure tapping 121 downstream of the flow restriction element 105, and is configured to measure the differential pressure DP between the first and second pressure tapping positions.

A first absolute pressure transmitter 109 is connected through impulse piping 110 at the first pressure tapping 120 and is configured to measure the static pressure P1 at the first pressure tapping 120.

A recovered absolute pressure transmitter 111 is connected through impulse piping 112 at the recovered pressure tapping 122 and is configured to measure the recovered static pressure P3 at the recovered pressure tapping 122.

An optional second absolute pressure transmitter 113 is connected through impulse piping 114 at the second pressure tapping 121 and is configured to measure the downstream static pressure P2 at the second pressure tapping 121. Because it is optional, in FIG. 1 the second absolute pressure transmitter 113 is marked in a dotted line.

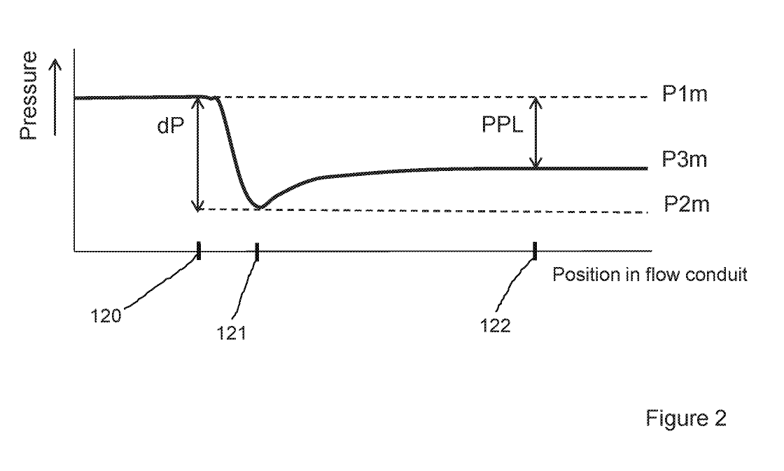

FIG. 2 shows the profile of the static pressure against position in the process piping 104 shown in FIG. 1. The pressure tapping positions 120, 121, 122 are marked on the abscissa, the pressure in relative values is marked on the ordinate. Upstream of the orifice plate 105 the static pressure has the relatively high value P1m, as measured at the first pressure tapping 120 with the first absolute pressure transmitter 109. Pressure drops significantly across the orifice plate 105. The static pressure P2m at the second pressure tapping 121 closely downstream of the orifice plate 105 is significantly lower than the static pressure P1m upstream the orifice plate. In the further course of downstream flow, the static pressure recovers again to a value higher that P2m, but permanently lower than P1m. This is the so called recovered pressure, measured as P3m further downstream of the second pressure tapping 121 at a recovered pressure tapping 122 with the recovered pressure transmitter 111.

The difference between the recovered pressure P3m and the undisturbed static pressure upstream of the orifice plate 105 is called the Permanent Pressure Loss PPL. The difference between the static pressure P1m and P2m upstream and downstream close to the orifice plate 105 is the differential pressure dP and is measured with the differential pressure transmitter 106.

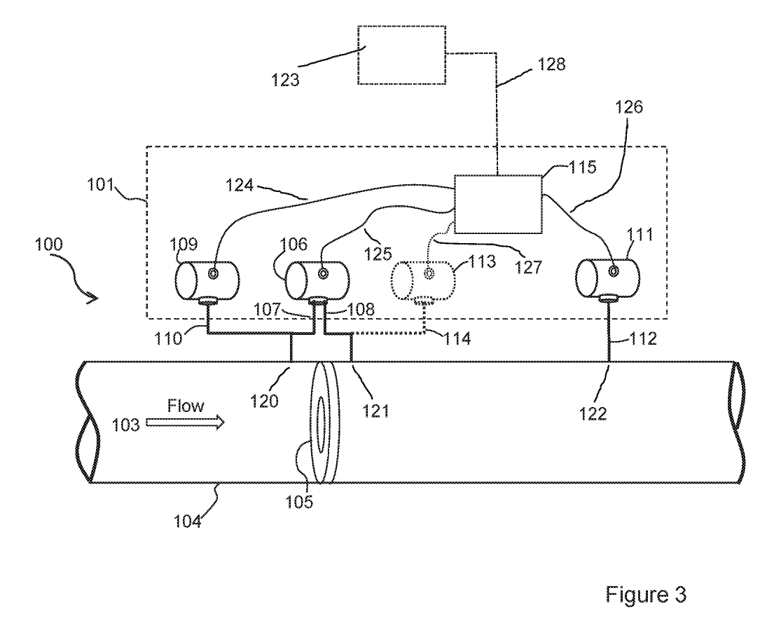

Turning now to FIG. 3, this shows a more detailed schematic of the flow metering system from FIG. 1. The differential pressure transmitter 106, the first pressure transmitter 109, the second pressure transmitter 111 and the optional third pressure transmitter 113 are shown to be integrated within a transmitter sub-system 101. It is indicated here schematically and exemplarily only by a box with dotted line, but can be realized in a variety of embodiments, including a common transmitter unit just a virtual transmitter unit.

The transmitters 109, 106, 111 and optionally 113 are connected to circuitry 115 that performs the diagnostics. Connection is shown here exemplarily and schematically only by signal lines 124, 125, 126, 127. These signal lines 124, 125, 126, 127 could be traditional two-wire analog signal lines or a wired or wireless digital communications signal line such as HART or wireless HART, Modbus and Foundation Fieldbus.

A typical example, although not shown in a figure, is a system where all the transmitters 109, 106, 113, 111 are connected to a flow computer and the diagnostics circuitry 115 is in the flow computer.

Circuitry 115 is optionally shown to be connected to a central location 123 by another signal line 128, due to the optional character indicate in a dotted line. The central location 123 can for instance be a control system or a flow computer. The communication of the transmitter with the central location is shown as signal line 128 and can be a traditional two-wire analog signal or a wired or wireless digital communications signal such as HART or wireless HART, Modbus and Foundation Fieldbus.

The circuitry 115 executes the diagnostic procedure as explained above. It determines the PPL according to equation (2) using the differential pressure measurement dP. It determines the calculated recovered pressure P3c according to equation (1), and optionally the calculated downstream pressure P2c according to equation (3). It observes a trend in changes of those parameters. Particularly, it observes a trend in the deviation between the calculated recovered pressure P3c and the measured recovered pressure P3m. With the present invention, the differential pressure and the two, or optionally three, static pressures are monitored over time. The measured static pressure value P3m is compared with the calculated value P3c. Variations over time, so called trends, of the measured and calculated static pressure values are monitored and used to identify a failing component. During normal operation, the deviation between the measured and calculated static pressure P3m−P3c value remains approximately zero. However, if there is problem with the system, the deviation will tend to increase or decrease. The circuitry will indicate a diagnostic problem once the deviation exceeds an expected value, for example zero, in either direction, either surmounting or falling below the expected value.

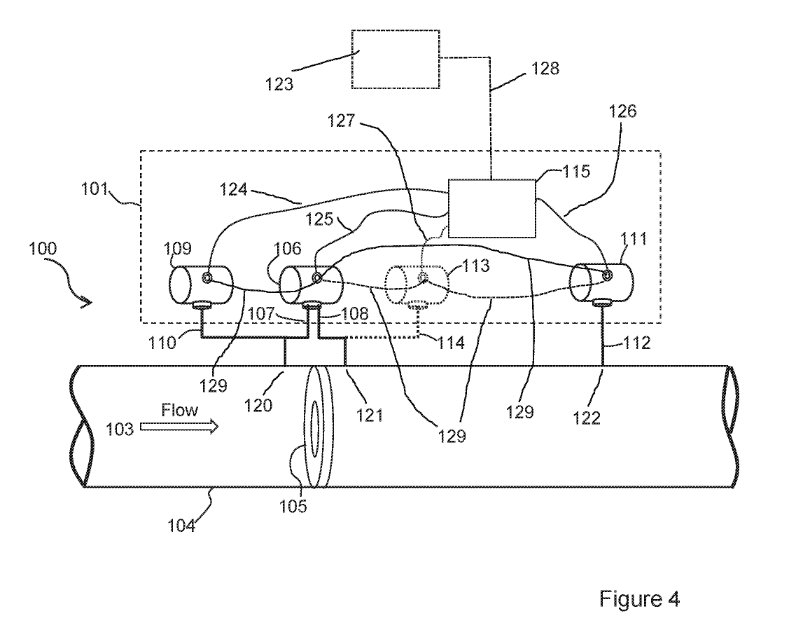

FIG. 4 shows another exemplary embodiment of the invention, where two or more of the differential pressure transmitter 106 and the pressure transmitters 109. 111 and 113 communicate with each other through a communication bus. The communication bus can be any wired or wireless industrial field bus system. Typical examples of the communication bus are as Foundation Fieldbus and (wireless) HART. In FIG. 4 the communication bus is indicated by bus lines 129.

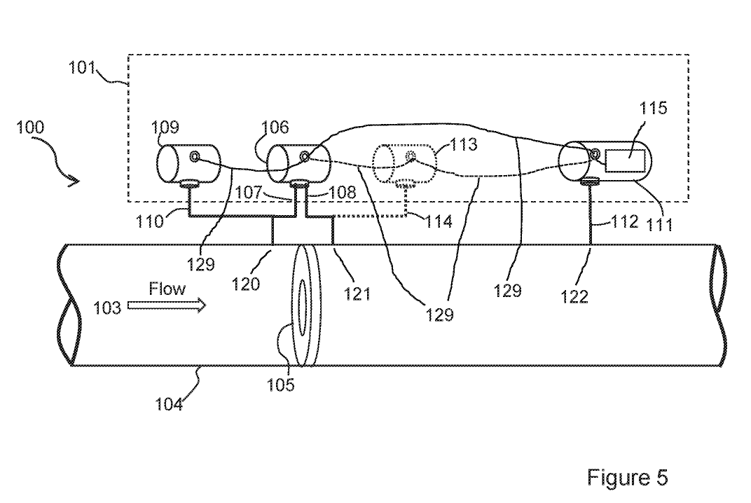

FIG. 5 shows another exemplary embodiment of the invention, which differs from the embodiment shown in FIG. 4 by that the circuitry 115 is implemented in one of the transmitters, here the recovered pressure transmitter 111.

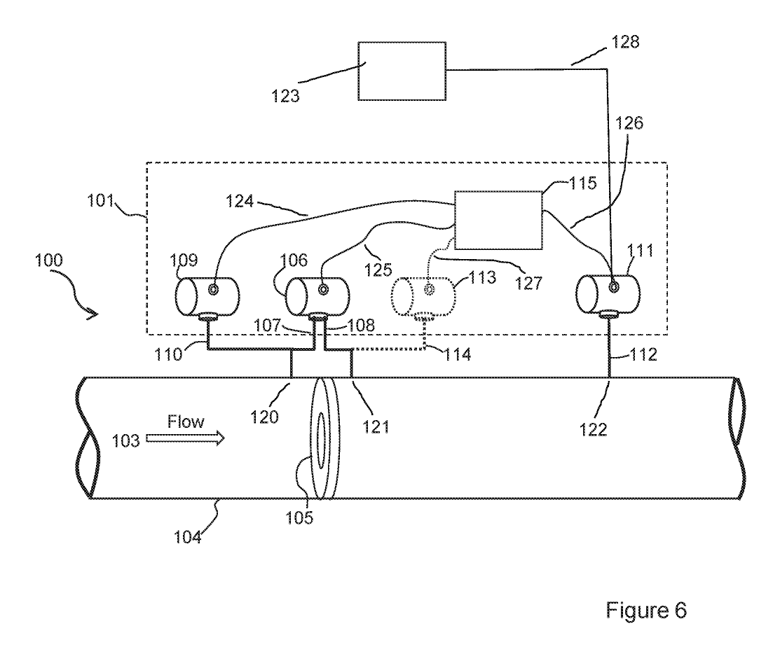

FIG. 6 shows another exemplary embodiment of the invention, which differs from the embodiment shown in FIG. 3 by that one of the transmitters, here just as example the recovered pressure transmitter 111 is configured for communication with a central location 123 and for this purpose is connected with the central location 123 via a signal line 128. The signal line 128 can be any of, but not limited to, 2-wire or 4-wire traditional transmitter cables, field bus cable or wireless communication path like wireless HART or Bluetooth.

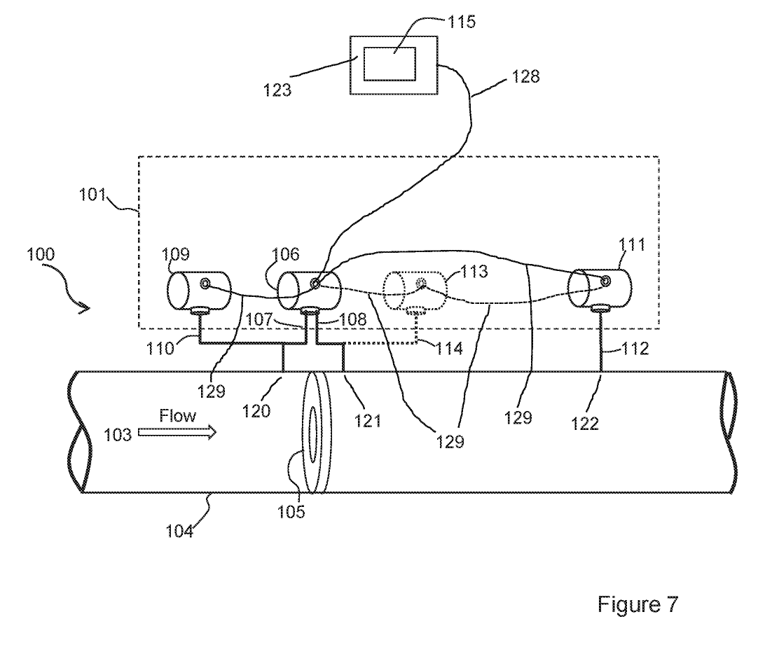

FIG. 7 shows another exemplary embodiment of the invention, which differs from the embodiment shown in FIG. 5 by that one or more transmitters, here as example only the differential pressure transmitter 106, communicate with a central location 123 in which the circuitry 115 is implemented. The central location 123 can for instance be a control system or a flow computer. The communication of the transmitter with the central location is shown as signal line 128 and can be a traditional two-wire analog signal or a wired or wireless digital communications signal such as HART or wireless HART, Modbus and Foundation Fieldbus.

In another exemplary embodiment, not shown here in the figures, two or more of the transmitters 109, 106, 111, 113, may be combined in a single device, for instance a multi-variable transmitter or a dual pressure transmitter.

Turning again to FIG. 8, this—as already mentioned—, shows an alternative schematic of the process piping 104 with the flow restriction element 105 and the location of the transmitters 113′, 106, 109′, 111, where the first pressure transmitter 109′ is located at the downstream pressure tapping 121, and an optional second pressure transmitter 113′ is located at the upstream pressure tapping 120. The various embodiments shown in FIGS. 3 to 7 using different kinds of connection modes can of course in an analogue way also be realized with the transmitter scheme as shown in FIG. 8.

Summing up, in accordance with the present invention, by using one differential pressure transmitter, one first absolute pressure transmitter either upstream or downstream the flow obstruction and an additional absolute pressure measurement at the recovered pressure location P3 and optionally an additional absolute pressure transmitter located on the opposite side of the flow obstruction in relation to the first absolute pressure transmitter, it is possible to detect various problems in the flow system.

The present invention is based on additional absolute pressure transmitters instead of differential pressure transmitters, which provides the capability to not only reveal an issue with the flow restriction element and the differential pressure transmitter but also with the static pressure measurement. The additional diagnostics capability for pressure transmitters is not provided by prior art solutions.

Furthermore the current invention has the advantage over the prior art that mass flow calculations are not necessary for the diagnostics and that the measuring system does not require calibration.

Although the present invention has been described with reference to preferred embodiments, workers skilled in the art will recognize that changes may be made in form and detail without departing from the spirit and scope of the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

100 flow metering system

101 transmitter subsystem

103 liquid medium

104 fluid conduit

105 fluid obstruction

106 dP transmitter

107 impulse piping

108 impulse piping

109 first pressure transmitter

109′ first pressure transmitter

110 impulse piping

111 recovered pressure transmitter

112 impulse piping

113 second pressure transmitter

113′ second pressure transmitter

114 impulse piping

115 circuitry

120 first pressure tapping

121 second pressure tapping

122 recovered pressure tapping

123 central location

124 signal line

125 signal line

126 signal line

127 signal line

128 signal line

129 bus line

1. A method of metering flow through a fluid conduit, the conduit having a fluid obstruction, the method comprising:
measuring a differential pressure taken between a first conduit position upstream of the fluid obstruction and a second conduit position downstream of the fluid obstruction;
calculating a fluid flow rate using the differential pressure measurement;
measuring a first static pressure upstream or downstream of the fluid obstruction;
measuring a recovered pressure at a recovered pressure location downstream of the fluid obstruction; and
performing diagnostics based on parameters derived from the differential pressure, the first static pressure, and the measured recovered pressure.

2. The method of claim 1, further comprising:
performing diagnostics based upon observing a trend in changes of diagnostic parameters derived from the differential pressure, the first static pressure, and the measured recovered pressure.

3. The method of claim 1, further comprising:
deriving a calculated recovered pressure downstream of the fluid obstruction from the differential pressure and the first static pressure; and
deriving a diagnostic parameter from the calculated recovered pressure and the measured recovered pressure.

4. The method of claim 3, further comprising:
deriving the diagnostic parameter from the deviation between the calculated recovered pressure and the measured recovered pressure;
observing a trend of the deviation between the calculated recovered pressure and the measured recovered pressure; and
indicating a diagnostic issue once the deviation exceeds an expected value.

5. The method of claim 1, further comprising:
measuring a second static pressure downstream of the fluid obstruction, in case the first static pressure is measured upstream of the fluid obstruction, or measuring a second static pressure upstream of the fluid obstruction, in case the first static pressure is measured downstream of the fluid obstruction; and
performing diagnostics based on parameters derived from the differential pressure, the first static pressure, the measured recovered pressure, and the measured second static pressure.

6. The method of claim 5, further comprising:
performing diagnostics based upon observing a trend in changes of parameters derived from the differential pressure, the first static pressure, the measured recovered pressure, and the measured second static pressure.

7. The method of claim 6, further comprising:
deriving a calculated second static pressure downstream of the fluid obstruction, the first static pressure being measured upstream of the fluid obstruction, from the differential pressure and the first static pressure; and
deriving a further diagnostic parameter from the measured second static pressure and the calculated second static pressure.

8. The method of claim 7, further comprising:
deriving the further diagnostic parameter from the deviation between the measured second static pressure and the calculated second static pressure; and
observing a trend of the deviation between the measured second static pressure, and the calculated second static pressure; and
indicating a diagnostic issue once the deviation exceeds an expected value.

9. The method of claim 6, further comprising:
deriving a calculated second static pressure downstream of the fluid obstruction, the first static pressure being measured upstream of the fluid obstruction from the differential pressure and the first static pressure; and
deriving a further diagnostic parameter from the measured second static pressure and the calculated second static pressure.

10. The method of claim 9, further comprising:
deriving the further diagnostic parameter from the deviation between the measured second static pressure and the calculated second static pressure; and
observing a trend of the deviation between the measured second static pressure and the calculated second static pressure; and
indicating a diagnostic issue once the deviation exceeds an expected value.

11. The method of claim 1, further comprising:
measuring a second static pressure downstream of the fluid obstruction, the first static pressure being measured upstream of the fluid obstruction; and
performing diagnostics based on parameters derived from the differential pressure, the first static pressure, the measured recovered pressure, and the measured second static pressure.

12. The method of claim 11, further comprising:
performing diagnostics based upon observing a trend in changes of parameters derived from the differential pressure, the first static pressure, the measured recovered pressure, and the measured second static pressure.

13. The method of claim 1, further comprising:
measuring a second static pressure upstream of the fluid obstruction, the first static pressure being measured downstream of the fluid obstruction; and
performing diagnostics based on parameters derived from the differential pressure, the first static pressure, the measured recovered pressure and the measured second static pressure.

14. The method of claim 13, further comprising:
performing diagnostics based upon observing a trend in changes of parameters derived from the differential pressure, the first static pressure, the measured recovered pressure, and the measured second static pressure.

15. A flow metering system, comprising:
a fluid conduit including a fluid obstruction;
a first pressure tapping at a location upstream of the fluid obstruction;
a second pressure tapping at a location downstream of the fluid obstruction;
a differential pressure transmitter, arranged for measuring the differential pressure between the first and second pressure tapping;
a recovered pressure tapping at a recovered pressure location downstream of the second pressure tapping;
a first pressure transmitter, arranged for measuring the static pressure at the first pressure tapping or a first pressure transmitter arranged for measuring the static pressure at the second pressure tapping;
a recovered pressure transmitter, arranged for measuring the static recovered pressure at the recovered pressure tapping;
a circuitry, configured to perform diagnostics based on parameters derived from the differential pressure, the first static pressure, and the measured recovered pressure.

16. The system of claim 15, further comprising:
a second pressure transmitter, arranged for measuring the static pressure at the second pressure tapping, in case the first pressure transmitter is arranged at the first pressure tapping, or arranged at the first pressure tapping, in case the first pressure transmitter is arranged at the second pressure tapping,
wherein the circuitry is further configured to perform diagnostics based on parameters derived from the differential pressure, the first static pressure, the measured recovered pressure, and the measured second static pressure.

17. The system of claim 15, wherein the transmitters are configured to communicate with each other.

18. The system of claim 15, wherein the circuitry is located within one of the transmitters.

19. The system of claim 15, wherein at least one of the transmitters is configured to communicate with a central location.

20. The system of claim 19, wherein the circuitry is located within the central location.
